(19) United States
(12) Patent Application Publication
(10) Pub. No.: US 2011/0113265 A1
(43) Pub. Date: May 12, 2011

(54) CIRCUIT SYSTEM AND CONTROL METHOD THEREOF

(76) Inventors: Hou-Yuan LIN, Taipei Hsien (TW); Chen-Shun Chen, Taipei Hsien (TW); Tse-Hsine Liao, Taipei Hsien (TW)

(21) Appl. No.: 12/765,374

(22) Filed: Apr. 22, 2010

(30) Foreign Application Priority Data
Nov. 11, 2009 (TW) 98138197

(51) Int. Cl. G06F 1/00

(52) U.S. Cl. 713/300

(57) ABSTRACT

A circuit system is provided, including a processing unit, a control unit electrically connected to the processing unit, and a plurality of PWM units electrically connected to the control unit. The processing unit transmits a control signal to the control unit according to a load current value of the circuit system, and the control unit enables at least one of the PWM units according to the control signal.

### CROSS REFERENCE TO RELATED APPLICATIONS

This Application claims priority of Taiwan Patent Application No. 098138197, filed on Nov. 11, 2009, the entirety of which is incorporated by reference herein.

### BACKGROUND OF THE INVENTION

1. Field of the Invention

This application relates in general to a circuit system and in particular to a circuit system having PWM units.

2. Description of the Related Art

Conventional computer motherboards usually comprise multiphase Pulse Width

Modulation (PWM) devices, such as 1-phase 2-phase, 3-phase, 4-phase, 5-phase, 6-phase, 7-phase, 8-phase or more than 8-phase PWM controllers. Since the PWM devices have limited operating life, breakdown of the PWM devices after long term usage may lead to breakdown of computer operating systems. Hence, extending operating life of the PWM devices and preventing breakdown of motherboard systems have become critical issues in the related fields.

### BRIEF SUMMARY OF INVENTION

The application provides a circuit system, including a processing unit, a control unit electrically connected to the processing unit, and a plurality of PWM units electrically connected to the control unit. The processing unit transmits a control signal to the control unit according to a load current value of the circuit system, and the control unit enables at least one of the PWM units according to the control signal.

### BRIEF DESCRIPTION OF DRAWINGS

The invention can be more fully understood by reading the subsequent detailed description and examples with references made to the accompanying drawings, wherein:

FIG. 1 is a perspective diagram of a circuit system according to an embodiment of the invention; and

FIG. 2 is a perspective diagram illustrating a control method of a circuit system according to an embodiment of the invention.

### DETAILED DESCRIPTION OF INVENTION

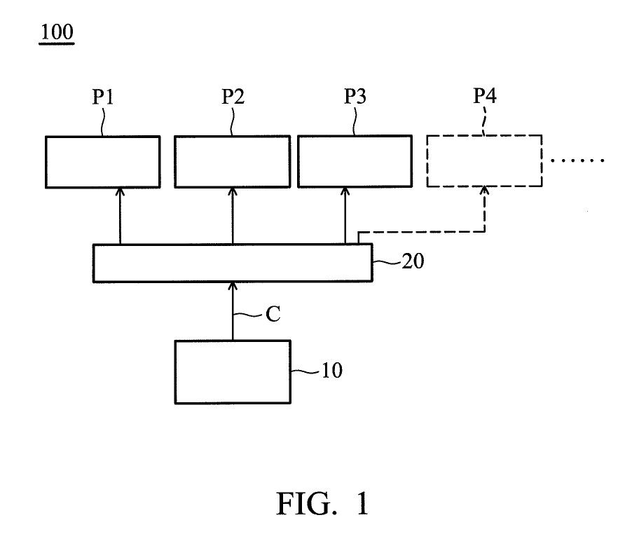

Referring to FIG. 1, an embodiment of a circuit system 100 is disposed in a computer motherboard and primarily comprises a first PWM unit P1, a second PWM unit P2, a third PWM unit P3, a processing unit 10, and a control unit 20, wherein the PWM units P1-P3 and the processing unit 10 are electrically connected to the control unit 20. The processing unit 10 can transmit a control signal C to the control unit 20 according to a load current value of the circuit system 100. Subsequently, the control unit 20 enables at least one of the three PWM units P1˜P3 according to the control signal C. In some embodiments, the processing unit 10 and the control unit 20 may comprise two independent ICs or be integrated into a single IC device.

As shown in FIG. 1, there are three PWM units P1-P3 in the circuit system 100. However, the circuit system 100 may comprise two or more than two PWM units when practically applied. For example, the circuit system 100 of FIG. 1 may comprise only the PWM units P1 and P2. In addition to the PWM units P1 and P2, the circuit system 100 may further comprise the PWM units P3 and P4 or more.

When the load current value of the circuit system 100 exceeds a predetermined value, the control unit 20 may enable a plurality of PWM units to share the load current, and spread the load current among each PWM unit. In some embodiments, the plurality of PWM units can comprise a multiphase PWM module. For example, two 2-phase PWM units may be incorporated with each other as a 4-phase PWM module, and two 6-phase PWM units may be incorporated with each other as a 12-phase PWM module, and so on.

Additionally, the control unit 20 may enable the PWM units P1-P3 for a designated period in turn to prevent breakdown during long term usage thereof. Furthermore, the PWM units P1-P3 can also be randomly enabled. In this embodiment, the control unit 20 enables the first PWM unit P1 and disables the second PWM unit P2 when the computer is started. On the contrary, the control unit 20 enables the second PWM unit P2 and disables the first PWM unit P1 when the computer is restarted or rebooted. Thus, since every time the computer is started, different PWM units are enabled, load current and operating time for each PWM unit are efficiently allocated to extend life of usage.

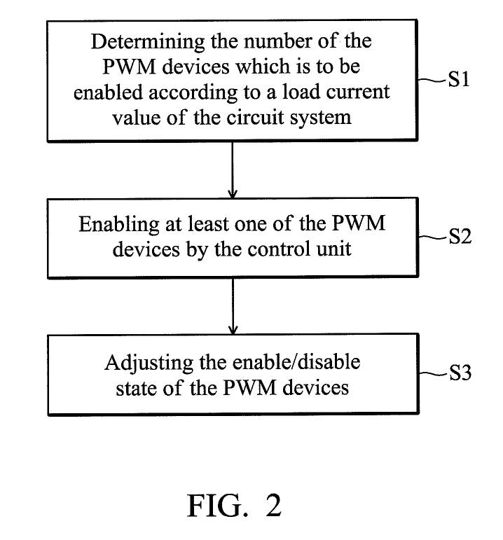

FIG. 2 illustrates a control method in accordance with the circuit system 100 of FIG. 1. The first step S1 of the control method is to determine the number of the PWM devices which is to be enabled according to a load current value of the circuit system 100. For example, if the load current value is low, it may be adequate to apply only one PWM unit to maintain functionality of the circuit system 100. However, if the load current value is high, two or more PWM units may be applied to share the load current. In the step S2, at least one of the PWM devices P1-P3 is enabled by the control unit 20. The control unit 20 can select and enable at least one of the PWM devices P1-P3 according to the number of the PWM devices given by the step S1. The control unit 20 can further adjust the enable/disable state of the PWM devices P1-P3 (step S3); so as to evenly distribute the load current and operating time of the PWM devices P1-P3 to extend life of usage.

In this embodiment, the PWM devices may be selected and enabled by random. Additionally, when a PWM device breaks down during usage, the control unit 20 may disable the PWM device that broke down and enable another PWM device to replace the broken down PWM device. For example, when the first PWM device P1 breaks down, the control unit 20 disables the first PWM device P1 and enables the second PWM device P2 to replace the first PWM device P1. In some embodiments, when the first and second PWM devices P1 and P2 both breakdown, the control unit 20 may disable the first and second PWM devices P1 and P2 and enable the third PWM device P3 to maintain functionality of the circuit system.

The application provides a circuit system and control method thereof. The circuit system comprises at least two PWM units which are enabled in turn or by random, so as to evenly distribute the load current and operating time for each PWM unit. When a PWM device breaks down during usage, another PWM device can be enabled to replace the broken down PWM device to maintain functionality of the circuit system. Thus, for PWM units and motherboards, unneeded maintenance and repair work can be prevented, and extension of operating life can be achieved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A circuit system disposed in a computer motherboard, comprising:
a processing unit;
a control unit, electrically connected to the processing unit, wherein the processing unit transmits a control signal to the control unit according to a load current value of the circuit system;
a first PWM unit, electrically connected to the control unit; and
a second PWM unit, electrically connected to the control unit, wherein the control unit enables at least one of the first and second PWM units according to the control signal.

2. The circuit system as claimed in claim 1, wherein the control unit enables both of the first and second PWM units according to the control signal.

3. The circuit system as claimed in claim 1, wherein the control unit alternatively enables the first and second PWM units for a designated period according to the control signal.

4. The circuit system as claimed in claim 1, wherein the control unit enables at least one and the first or second PWM units by random.

5. The circuit system as claimed in claim 1, wherein the control unit enables the first PWM unit and disables the second PWM unit when the computer is started, and the control unit enables the second PWM unit and disables the first PWM unit when the computer is restarted or rebooted.

6. The circuit system as claimed in claim 1, wherein when the first PWM unit breaks down, the control unit disables the first PWM unit and enables the second PWM unit.

7. The circuit system as claimed in claim 1, wherein the circuit system further comprises a third PWM unit electrically connected to the control unit, and the control unit enables at least one of the first, second and third PWM units according to the control signal.

8. The circuit system as claimed in claim 7, wherein the control unit enables all of the first, second and third PWM units according to the control signal.

9. The circuit system as claimed in claim 7, wherein the control unit alternatively enables the first, second and third PWM units for a designated period according to the control signal.

10. The circuit system as claimed in claim 7, wherein the control unit enables at least one of the first, second or third PWM unit by random.

11. The circuit system as claimed in claim 7, wherein when any one of the first, second and third PWM units breaks down, the control unit disables the broken down PWM unit.

12. A control method of a circuit system, wherein the circuit system comprises a control unit and a plurality of PWM units electrically connected to the control unit, and the method comprises:
determining the number of the PWM devices which is to be enabled according to a load current value of the circuit system; and
enabling at least one of the PWM devices by the control unit.

13. The method as claimed in claim 12, wherein the control unit enables both of the first and second PWM units according to the control signal.

14. The method as claimed in claim 12, wherein the control unit alternatively enables the first and second PWM units for a designated period according to the control signal.

15. The method as claimed in claim 12, wherein the control unit enables at least one of the first and second PWM units by random.

16. The method as claimed in claim 12, wherein the control unit enables the first PWM unit and disables the second PWM unit when the computer is started, and the control unit enables the second PWM unit and disables the first PWM unit when the computer is restarted or rebooted.

17. The method as claimed in claim 12, wherein when the first PWM unit breaks down, the control unit disables the first PWM unit and enables the second PWM unit.

18. The method as claimed in claim 12, wherein the circuit system further comprises a third PWM unit electrically connected to the control unit, and the control unit enables at least one of the first, second and third PWM units according to the control signal.

19. The method as claimed in claim 18, wherein the control unit enables all of the first, second and third PWM units according to the control signal.

20. The method as claimed in claim 18, wherein the control unit enables the first, second and third PWM units for a designated period in turn according to the control signal.

21. The method as claimed in claim 18, wherein the control unit enables at least one of the first, second or third PWM unit by random.

22. The method as claimed in claim 18, wherein when any one of the first, second and third PWM units breaks down, the control unit disables the broken down PWM unit.
